(19) United States
(12) Patent Application Publication
(10) Pub. No.: US 2006/0164730 A1
(43) Pub. Date: Jul. 27, 2006

(54) Display device for fixing to spectacle lenses in a positively engaged manner

(76) Inventor: Frank Holler, Aalen (DE)

Correspondence Address: PATTERSON, THUENTE, SKAAR & CHRISTENSEN, P.A., 4800 IDS CENTER, 80 SOUTH 8TH STREET, MINNEAPOLIS, MN, 55402-2100, US

(21) Appl. No.: 10/520,734

(22) PCT Filed: Jul. 9, 2003
(86) PCT No.: PCT/EP03/07420

§ 371 Date: Jan. 30, 2006

(30) Foreign Application Priority Data
Jul. 11, 2002 (DE) 102 31 427.6

(51) Int. Cl. G02B 27/14

(52) U.S. Cl. 359/630

(57) ABSTRACT

What is provided is a display device comprising an image-generating element for generating an image, spectacles comprising spectacle lenses, first optics comprising a coupling-in element for coupling the generated image into the field of vision of a user wearing said spectacles, wherein the first optics, or a support to which the first optics are connectable, are (is) mounted on a first one of the spectacle lenses by means of a form-locking connection, and the coupling-in element is separated from the first spectacle lens by a gap.

This application claims priority to German patent application no. 102 31 427.6 filed Jul. 11, 2002, and International Application No. PCT/EP03/07420 filed Jul. 9, 2003. Said applications are incorporated by reference herein.

### BACKGROUND OF THE INVENTION

The invention relates to a display device comprising an image-generating element for generating an image, spectacles comprising spectacle lenses as well as first optics comprising a coupling-in element for coupling the generated image into the field of vision of a user wearing said spectacles.

Such a device is also referred to as an HMD device (Head Mounted Display device) and is suitable, for example, for persons in need of spectacles for correction of defective vision. The display device and the first optics are mounted on the earpieces of the spectacles (for correction of defective vision). Such mounting on the earpieces of spectacles is, in many cases, not very stable, so that the use of the HMD device is negatively affected, because, for example by a movement of the first optics relative to the spectacles, the image generated by means of the image-generating element is also moved in a manner not desired by the person wearing said spectacles.

In view thereof, it is an object of the invention to provide a display device comprising an image-generating element for generating an image, spectacles comprising spectacle lenses, first optics comprising a coupling-in element for coupling the generated image into the field of vision of a user wearing said spectacles, said display device achieving secure fixation of the coupling-in element relative to the spectacles.

### SUMMARY OF THE INVENTION

According to the invention, the object is achieved by a display device comprising an image-generating element for generating an image, spectacles comprising spectacle lenses, first optics comprising a coupling-in element for coupling the generated image into the field of vision of a user wearing said spectacles, wherein the first optics, or a support to which the first optics are connectable, are (is) mounted on a first one of the spectacle lenses by means of a form-locking connection, and the coupling-in element is separated from the spectacle lens by a gap.

Said form-locking connection with the first spectacle lens ensures that the position of the coupling-in element relative to the first spectacle lens is unchangeable, so that an excellent image display can be guaranteed. A form-locking connection as used herein means any connection which prevents movement of the first optics relative to the first spectacle lens by form-interlocking of at least two elements of the connection.

Since the coupling-in element is separated from the first spectacle lens by a gap, this has the further advantageous consequence that a correcting effect of the first spectacle lens remains unchanged, if it serves to correct deficient vision. This would not be the case if the coupling-in element were in contact with the spectacle lens.

Both spectacle lenses (one spectacle lens each for each eye of the user) or only one spectacle lens of the spectacles may serve to correct deficient vision. It is also possible that both spectacle lenses do not serve to correct deficient vision. This may be the case if the spectacles are protective goggles, for example.

In an advantageous embodiment of the display device according to the invention, the first optics or the first support are (is) mounted on the first spectacle lens by means of a screw connection. In this case, the form-locking connection is realized by the screw(s) and the corresponding holes in the spectacle lens as well as in the first optics or in the first support, respectively. This type of connection may be easily effected in analogy with the mounting of spectacle earpieces and of the bridge in frameless spectacles. This ensures a secure and exactly fixed position of the coupling-in element relative to the first spectacle lens, so that the image display quality of the image generated by means of the image-generating element is very high.

For example, the screw connection may be realized by means of at least one bolt, at least one cap screw, which is screwed into a threaded through-hole or a tapped blind hole in the first optics or the first support, respectively, through a through-hole in the first spectacle lens, or by at least one fit screw.

In particular, the first optics or the first support, respectively, may be screwed into the first spectacle lens by at least two screws. This ensures very great stability of the connection.

Further, in the display device according to the invention, the first optics or the first support, respectively, may be connected to the first spectacle lens in the edge region, preferably in the upper edge region of the first spectacle lens. This has the advantageous effect that the field of vision of the user wearing the spectacles is hardly reduced by mounting the first optics or the first support, respectively, on the spectacle lens.

In particular, the first spectacle lens may be located between the coupling-in element and an eye of the user wearing the spectacles. In this arrangement, there is sufficient space for the coupling-in element, because it can be mounted and arranged on that side of the first spectacle lens which is turned away from the user.

A particularly preferred embodiment of the display device according to the invention consists in that the first optics, or their support, are connectable to the first support by means of a further form-locking connection. This creates a secure and permanent connection of the first optics to the first spectacle lens via the first support.

Further, in the display device according to the invention, the first optics or their support, respectively, may be releasably connected to the first support. This leads to the advantage that the first optics are connected to the spectacles only if required and, otherwise, further normal use of the spectacles can be made (for correction of defective vision).

In the display device according to the invention, the coupling-in element may cause folding of the optical path for light rays of the image which come from the image-generating element. This achieves the advantage that the image-generating element as well as, if required, further optical elements of the first optics can be arranged above the coupling-in element, so that the depth of the display device in the viewing direction of the user can be kept small.

In particular, the coupling-in element may cause said folding of the optical path by means of a beam splitter, which is arranged such that the generated image is perceivable, by a user wearing the spectacles, as superimposed on the environment. This enables the so-called augmented representation, wherein the generated image is reflected in such a way that the user can perceive the generated image in addition to the environment.

The coupling-in element may comprise a deflecting mirror for folding the optical path. Thus, a simple means of folding the optical path is provided which allows very good imaging quality to be achieved.

In a preferred further embodiment, the display device according to the invention may also comprise further elements which are required to generate images (e.g. a control unit for the image-generating element as well as a voltage or power supply, respectively). These further elements may be provided in or on the housing or may be connected thereto. In particular, the control unit may be connected to the image-generating element wirelessly or by means of a line. The data required to generate images can be transmitted to the control unit either wirelessly or via a line.

Further, the display device according to the invention may also comprise an adjusting device, using which the position and orientation of the coupling-in element and/or of the first optics relative to the first spectacle lens can be adjusted and fixed. For this purpose, suitable adjusting device may be provided, for example, on the first support or on the support of the first optics. This embodiment easily enables an exact adjustment of the coupling-in element and/or of the first optics relative to the first spectacle lens, so that, for example, a form-locking connection, in which the coupling-in element and/or the first optics is (are) not optimally aligned with the spectacle lens, may be corrected by the adjusting device.

A particularly preferred embodiment of the display device according to the invention consists in that it provides a further image-generating element for generating a further image, as well as second optics comprising a further coupling-in element for coupling the further image into the field of vision of a user wearing said spectacles, wherein the second optics, or a second support to which the second optics are connectable, are (is) mounted on the second spectacle lens by means of a form-locking connection, and the further coupling-in element of the second optics is separated from the second spectacle lens by a gap. Thus, different images can be generated for both eyes of the user and supplied to the eyes, which enables, in particular, a three-dimensional display.

The further coupling-in element or the second support, respectively, may be further embodied in the same way as the coupling-in element of the first optics or the first support, respectively.

As the image-generating element, use may be made, for example, of a luminous display, e.g. a background-lit LCD or an LED, or, for example, of a non-luminous display. The image-generating element can also comprise a so-called (spatial) light valve (for example a tilting mirror matrix (e.g. from Texas Instruments) comprising a plurality of tilting mirrors arranged in lines and columns).

### DESCRIPTION OF THE FIGURES

The invention is explained in more detail below, essentially by way of example, with reference to the drawings, wherein:

FIG. 1 schematically shows a front view of a first embodiment of the display device according to the invention;

FIG. 2 schematically shows an enlarged lateral view of the display device shown in FIG. 1, and

FIG. 3 schematically shows a perspective view of a support to be mounted on the spectacle lens and of an HMD module according to a further embodiment.

### DETAILED DESCRIPTION OF THE PREFERRED EMBODIMENTS

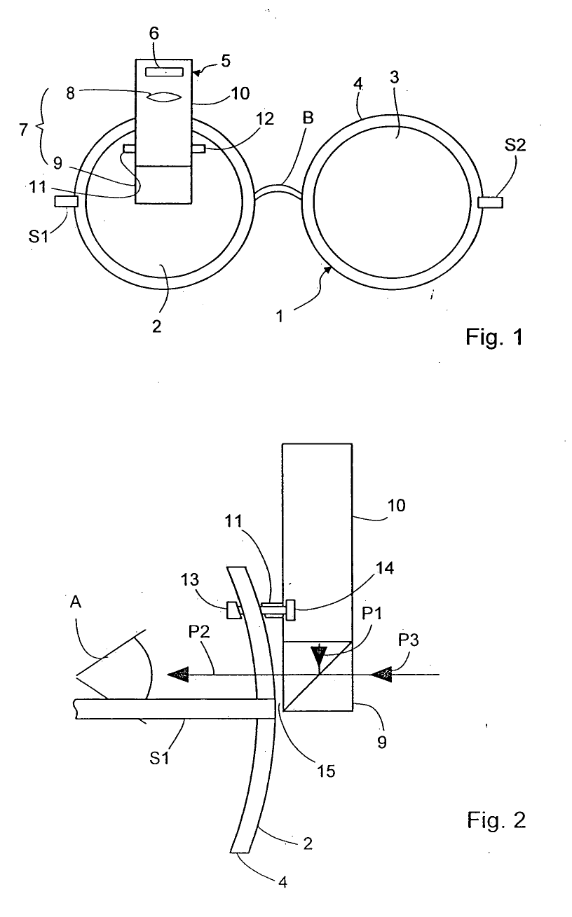

As is evident from FIG. 1, the display device according to the invention comprises spectacles 1 with first and second spectacle lenses 2, 3, which are held in a conventional spectacle frame 4 comprising a bridge B and two earpieces S1 and S2, as well as an HMD module 5.

The HMD module 5, which is schematically shown in FIG. 1, comprises an image-generating element 6 (such as, for example, a background-lit LCD module), using which an image can be generated, which is coupled into the field of vision of a user wearing the spectacles 1, via first optics 7, in such a manner that the user can perceive the image.

The first optics 7 comprise imaging optics 8, which are represented by a schematically shown lens, as well as a coupling-in element 9, which is a splitter cube in the embodiment example described herein.

The imaging optics 8 and the image-generating element 6 are arranged in a housing 10 and are drawn in thinner lines, because they are actually concealed by the cover 10 and not visible in the representation of FIG. 1, and the splitter cube 9 is connected to the housing 10 at the open lower end of the housing 10.

The housing 10 further comprises two flanges 11, 12, each of them protruding laterally, as seen in the front view of FIG. 1, and being securely screwed into the spectacle lens 2. To this end, a through-hole is provided in each flange 11, 12 and two further through-holes associated with the through-holes of the flanges 12 and 13 are provided in the first spectacle lens 2. As is best seen in FIG. 2, a screw 13 is passed through said through-holes, from the side of the first spectacle lens 2 facing the viewer, said screw 13 having a nut 14 screwed on from the other side of the spectacle lens 2, so that the flanges 11 and 12 are pressed against the first spectacle lens 2 and a form-locking connection is present between the housing 10 and the first spectacle lens 2.

The flanges 11 and 12 are provided such that, in the mounted condition of the HMD module 5 on the first spectacle lens 2, as shown in FIG. 2, there is a gap 15 (air gap) between the coupling-in element 9 (splitter cube) and the first spectacle lens 2. This is particularly advantageous in case the spectacles 1 are spectacles for correction of defective vision, because the coupling-in element 9 does not influence the correcting effect of the first spectacle lens 2 due to said air gap.

The display device described in connection with FIG. 1 is provided for an augmented representation, because the user (indicated by a schematically shown eye A) wearing the spectacles 1 can perceive the image generated by the image-generating element 6 (and indicated by arrows P1 and P2) as superimposed on the environment (indicated by arrows P3) due to the splitter cube 9. Of course, instead of the splitter cube 9, a deflecting prism may be provided, for example, so that the generated image is no longer superimposed on the environment, but in the area of the generated image, the user can only perceive said image.

The HMD module 5 also comprises further elements (not shown) which are required to generate images, e.g. a control unit for the image-generating element 6 as well as a voltage or power supply, respectively. These elements may be provided in or on the housing 10 or may be connected thereto. In particular, the control unit may be connected to the image-generating element 6 wirelessly or by means of a line. The data required to generate images can be transmitted to the control unit either wirelessly or via a line.

In addition to the above-described screw connection by means of the bolts 13, two threaded through-holes (not shown) or tapped blind holes (not shown), which are associated with the through-holes in the first spectacle lens 2 and into which corresponding screws may be screwed, may be provided in the housing 10, for example. Such tapped blind holes may also be provided in the splitter cube 9 itself. In this case, a form-locking connection of the splitter cube 9 with the first spectacle lens is established.

It is further possible to mount an HMD module also on the second spectacle lens 3, which HMD module may be provided, for example, in a manner identical with the HMD module 5. In this case, in particular, a three-dimensional display is possible by accordingly generating the images, because the images for the right and left eye of the user can be generated separately and supplied separately to both eyes. In this connection, exact fixing is particularly advantageous, because only this allows to observe the eye distance that is of particular importance in stereoscopic viewing.

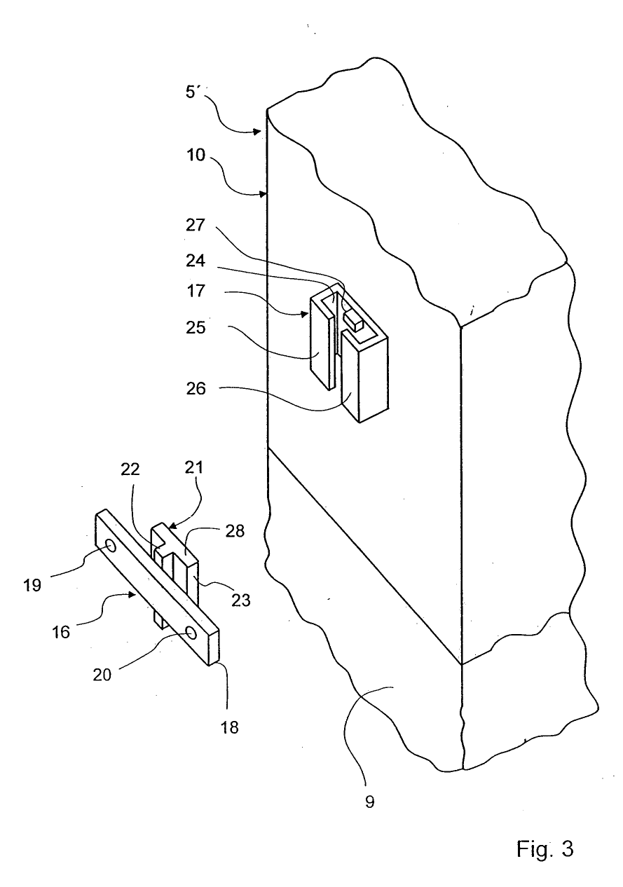

FIG. 3 is a perspective view showing a support 16 as well as part of an HMD module 5′ (which may be provided in a form corresponding substantially to the HMD module 5 of FIG. 1 and wherein the same elements as compared with the HMD module 5 are indicated by the same reference numerals) comprising a support counterpart 17 according to a further embodiment of the invention, which is mounted on the housing 10.

The support 16 comprises a mounting web 18 having two through-holes 19, 20, which are associated, in the same way as in the embodiment of FIG. 1 and 2, with two through-holes in the first spectacle lens 2. Thus, the support 16 can be securely screwed to the first spectacle lens 2 (as in the embodiment of FIG. 1 and 2), such that a form-locking connection is present. The mounting web 18 may be adapted to the curvature of the first spectacle lens 2 in such a way that it contacts the first spectacle lens 2 in the mounted condition.

A T-shaped guiding element 21 is mounted on the side of the mounting web facing away from the first spectacle lens 2 (in the mounted condition of the support 16). The guiding element 21 comprises a central web 22 which is connected to the mounting web 18, as well as a transverse web 23.

The support counterpart 17 mounted on the housing 10 comprises a T-groove 24, which is formed such that the support counterpart 17 can be placed on the guiding element 21 from above and then slid down, with the two free legs 25, 26 of the support counterpart 17 encompassing the transverse web 23 of the guiding element 21 on both sides.

Further, a stop element 27, which is supported on the upper end face 28 of the guiding element 21 in the connected condition, is provided in the T-groove 24 of the support counterpart 17. Thus, a releasable (form-locking) connection is provided between the support 16 and the housing 10, so that the HMD module 5′ may be connected to the spectacles 1 as required.

Although the description above contains many specificities, these should not be construed as limiting the scope of the invention but as merely providing illustrations of some of the presently preferred embodiments of the invention. Thus, the scope of the invention should be determined by the appended claims and their legal equivalents, rather than by the examples given.

1. A display device comprising an image-generating element for generating an image, spectacles comprising spectacle lenses, first optics comprising a coupling-in element for coupling the generated image into the field of vision of a user wearing said spectacles, wherein the first optics are mounted on a first one of the spectacle lenses by means of a form-locking connection, and the coupling-in element is separated from the first spectacle lens by a gap.

2. The display device as claimed in claim 1, wherein the first optics are mounted on the first spectacle lens by means of a screw connection.

3. The display device as claimed in claim 1, wherein the first optics are screwed onto the first spectacle lens by means of at least two screws.

4. The display device as claimed in claim 1, wherein the first optics are connected to the first spectacle lens in the edge region, preferably the upper edge region of the first spectacle lens.

5. The display device as claimed in claim 1, wherein the first spectacle lens is located between the coupling-in element and an eye of the user wearing the spectacles.

6. The display device as claimed in claim 1, wherein the coupling-in element causes folding of the optical path for light rays of the image which come from the image-generating element.

7. The display device as claimed in claim 1, wherein the coupling-in element causes said folding of the optical path by means of a beam splitter, which is arranged such that the generated image is perceivable, by a user wearing the spectacles, as superimposed on the environment.

8. The display device as claimed in claim 1, wherein the coupling-in element comprises a deflecting mirror for folding the optical path.

9. The display device as claimed in claim 1, wherein an adjusting device is provided, using which the position and orientation of at least one of the coupling-in element and the first optics relative to the first spectacle lens can be adjusted and fixed.

10. The display device as claimed in claim 1, wherein a further image-generating element for generating a further image, as well as second optics comprising a further coupling-in element for coupling the further image into the field of vision of a user wearing said spectacles are provided, wherein one of the second optics and of a second support to which the second optics are connectable is mounted on the second spectacle lens by means of a form-locking connection, and the further coupling-in element of the second optics is separated from the second spectacle lens by a gap.

11. A display device comprising an image-generating element for generating an image, spectacles comprising spectacle lenses, first optics comprising a coupling-in element for coupling the generated image into the field of vision of a user wearing said spectacles, and a first support to which the first optics are connectable, wherein the first support is mounted on a first one of the spectacle lenses by means of a form-locking connection, and the coupling-in element is separated from the first spectacle lens by a gap.

12. The display device as claimed in claim 11, wherein the first support is mounted on the first spectacle lens by means of a screw connection.

13. The display device as claimed in claim 11, wherein the first support is screwed onto the first spectacle lens by means of at least two screws.

14. The display device as claimed in claim 11, wherein the first support is connected to the first spectacle lens in the edge region, preferably the upper edge region of the first spectacle lens.

15. The display device as claimed in claim 1, wherein the first spectacle lens is located between the coupling-in element and an eye of the user wearing the spectacles.

16. The display device as claimed in claim 11, wherein the first optics, or their support, respectively, are (is) connectable to the first support by means of a further form-locking connection.

17. The display device as claimed in claim 11, wherein the first optics, or their support, respectively, are (is) releasably connected to the first support.

18. The display device as claimed in claim 11, wherein the coupling-in element causes folding of the optical path for light rays of the image which come from the image-generating element.

19. The display device as claimed in claim 11, wherein the coupling-in element causes said folding of the optical path by means of a beam splitter, which is arranged such that the generated image is perceivable, by a user wearing the spectacles, as superimposed on the environment.

20. The display device as claimed in claim 11, wherein the coupling-in element comprises a deflecting mirror for folding the optical path.

21. The display device as claimed in claim 11, wherein an adjusting device is provided, using which the position and orientation of at least one of the coupling-in element and the first optics relative to the first spectacle lens can be adjusted and fixed.

22. The display device as claimed in claim 11, wherein a further image-generating element for generating a further image, as well as second optics comprising a further coupling-in element for coupling the further image into the field of vision of a user wearing said spectacles are provided, wherein one of the second optics and of a second support to which the second optics are connectable, is mounted on the second spectacle lens by means of a form-locking connection, and the further coupling-in element of the second optics is separated from the second spectacle lens by a gap.
